(19) United States
(12) Patent Application Publication
(10) Pub. No.: US 2019/0364875 A1
(43) Pub. Date: Dec. 5, 2019

(54) MOUSETRAP

(71) Applicant: Pengyu FANG, Zhongshan (CN)

(72) Inventor: Pengyu FANG, Zhongshan (CN)

(21) Appl. No.: 16/480,248

(22) PCT Filed: Jan. 4, 2018
(86) PCT No.: PCT/CN2018/071245

§ 371 Date: Jul. 23, 2019

(30) Foreign Application Priority Data
Jan. 23, 2017 (CN) 201720093594.4

(51) Int. Cl. A01M 23/06; A01M 23/18

(52) U.S. Cl. CPC A01M 23/06; A01M 2200/00; A01M 23/18

(57) ABSTRACT

A mousetrap, includes a box body with a motor, a trigger mechanism including a supporting rod/rods capable of moving up and down and supporting a top cover, and a support locking mechanism capable of rotating and supporting the supporting rod/rods, a transmission rod hinged to the front side plate having a clamping position matching with a locking part on the support locking mechanism; between the output shaft of the motor and the transmission rod, a cable for pulling the transmission rod to rotate is provided; a reset spring/springs for resetting the transmission rod is/are provided; and the top cover is provided with a pedal, both of them are respectively provided with a conductive contact piece which can be contacted to drive the motor when the pedal moves downwards by tread of a mouse, and separated by a return spring/springs.

### TECHNICAL FIELD

The invention relates to a mousetrap.

### BACKGROUND ART

With the evolution of rodents, the use effect of present mousetrap is worse and worse. Once the mice enter a place where the medicines cannot be used, they are difficult for deratization.

Most of the existing mouse trapping and killing instruments (clamps, cages, mouse sticking boards, boxes and the like) are in forms of entry type trapping or completely exposed trapping, so that with the evolution of rodents, there are more and more crafty and smart mice, and when facing the entry type mousetrap such as mouse cages and the like, many mice do not enter them; and the captured or killed mice cannot be hided in the exposed type mousetrap, such as the mouse clamps and sticking boards, and other mice can easily find the threat that these instruments pose and avoid them consciously. Therefore, the actual use effect of the existing mousetrap is not good.

China patent “a novel flip-type mousetrap” with an authorization notification number CN 205658247U discloses a mousetrap, which is convenient for hiding a captured mouse after the mouse is captured by the mousetrap, thereby achieving the purpose of good mouse capturing effect. However, the mousetrap also has disadvantages that the trigger mechanism of the mousetrap is not sensitive in action, easily causing the phenomenon of clamping stagnation, so that the mousetrap with the structure still has an improved space.

Therefore, the invention emerges at the right moment.

### SUMMARY OF THE INVENTION

The invention is directed to overcome the defects of the prior art, and provides a mousetrap which is simple in structure, sensitive in action and good in mousetrap effect.

The invention is realized by the following technical scheme.

A mousetrap, comprising a box body 1 with an opening at the upper end, a top cover 2 which can rotate relative to the box body 1 to close the opening of the box body 1, and a trigger mechanism capable of being triggered by a mouse/mice climbing on the top cover 2 to turn over the top cover 2, the box body 1 includes a bottom plate 11 and a front side plate 12, wherein the trigger mechanism includes a supporting rod 31/supporting rods 31 capable of moving up and down relative to the front side plate 12 and supporting the top cover 2, the box body 1 is provided with a support locking mechanism capable of rotating relative to the box body 1 and supporting the supporting rod/rods 31, a transmission rod 33 is hinged to the front side plate 12, and the transmission rod 33 is provided with a clamping position 331 capable of engaging with a locking part 321 on the support locking mechanism; a motor is further provided on the box body 1, between the output shaft 34 of the motor and the transmission rod 33, a cable 35 capable of pulling the transmission rod 33 to rotate downwards for unlocking the clamping position 331 and the locking part 321 so as to enable the support locking mechanism to rotate for restoration is provided; a reset spring 36 configured for rotating the transmission rod 33 upwards to resetting is also provided between the transmission rod 33 and the box body 1, and the top cover 2 is provided with a stepping pedal 37 which can move downwards after being treaded by a mouse, the stepping pedal 37 and the top cover 2 are respectively provided with a conductive contact piece 38 which can be contacted to energize the motor to rotate when the stepping pedal 37 moves downwards, and a return spring 39/return springs 39 capable of separating the conductive contact pieces 38 of the stepping pedal 37 and the top cover 2 is/are further provided between the stepping pedal 37 and the top cover 2.

In the mousetrap, the box body 1 is further provided with a secondary switch 30 electrically connected with the motor; when the support locking mechanism rotates relative to the box body 1 to support the supporting rod/rods 31, the support locking mechanism drives the secondary switch 30 to be switched on, and when the supporting and locking mechanism rotates to reset, the secondary switch 30 is switched off.

In the mousetrap, the support locking mechanism includes two rotating rods 322 hinged to the bottom plate 11, one end of each rotating rod 322 is bent to form a swinging rod 323, a linkage rod 324 hinged with the two swinging rods 323 and capable of pushing the supporting rod/rods 31 to move upwards when the rotating rods 322 rotate are arranged on the two swinging rods 323, the linkage rod 324 is provided with a locking rod 325 protruding upwards , and the locking part 321 is arranged on the locking rod 325; when the locking part 321 is clamped with the clamping position 331, the swinging rods 323 are in an inclined state respectively, so that when the locking part 321 is separated from the clamping position 331, the support locking mechanism can rotate to reset under the action of self gravity and the downward pressure of the top cover 2 by the supporting rod/rods 31.

In the mousetrap, a reset torsion spring 326 for driving the rotating rod 322 to rotate to reset when the locking part 321 and the clamping position 331 are unlocked is further arranged between each rotating rod 322 and the bottom plate 11.

In the mousetrap, the top cover 2 and the box body 1 are connected by a connecting shaft 13/connecting shafts 13, and a torsion spring 14 capable of driving the top cover 2 to reset quickly is sleeved on each connecting shaft 13.

In the mousetrap, the secondary switch 30 comprises a fixed contact piece 301 disposed on the box body land an elastic movable contact piece 302 capable of contacting with or separating from the fixed contact piece 301; the movable contact piece 302 is pushed by the swinging rod 323 into engagement with the fixed contact piece 301 when the support locking mechanism rotates to support the supporting rod/rods 31, and the movable contact piece 302 is separated from the fixed contact piece 301 when the clamping position 331 and the locking part 321 are unlocked and the support locking mechanism rotates to reset.

In the mousetrap, the clamping position 331 is a protruding column provided on the transmission rod 33, and the locking part 321 is a hook provided on the locking rod 325 and capable of hooking the protruding column.

In the mousetrap, the hook is provided with an inclined plane 327 or an arc surface capable of pushing the protruding column so as to push the transmission rod 33 to rotate when the swinging rods 323 rotate.

In the mousetrap, the linkage rod 324 is provided with at least one handle 328 for drawing the swinging rods 323 to rotate.

Compared with the prior art, the invention has the following advantages.

1. When the invention is used, the support locking mechanism is rotated, the locking part on the support locking mechanism is clamped and locked with the clamping position on the transmission rod; at the moment, the supporting rod is supported by the support locking mechanism, and the top cover is supported by the supporting rod, so that the top cover closes the opening of the box body. When a mouse climbs onto the top cover and reaches the stepping pedal, the stepping pedal moves downwards under the gravity of downward pressure, the conductive contact piece of the stepping pedal is engaged with the conductive contact piece on the top cover to conduct a control circuit so as to energize the motor to rotate, the cable is wound during the rotation of the output shaft of the motor, the transmission rod is pulled to rotate downwards by the cable, so that the clamping position on the transmission rod is separated from the locking part on the support locking mechanism, and the support locking mechanism is rotated to reset; at the moment, the supporting rod loses support of the support locking mechanism, the supporting rod moves downwards, and the top cover loses support and flips downwards; the mouse on the top cover falls into the box body during the flipping process, and the top cover closes the opening of the box body after the flipping reset, so that the mouse is captured in the box body. Due to the fact that the circuit is turned on by the conductive contact to enable the motor to rotate, once the motor rotates, the clamping position and the locking part are unlocked, and the top cover is turned over, so that the trigger mechanism is higher in sensitivity, the phenomenon of clamping stagnation does not occur, the weight of a mouse capable of triggering the trigger mechanism can be accurately controlled by selecting return springs with different elastic coefficients to avoid false triggering caused by vibration of small insects such as cockroaches and the like and improve the mouse trapping effect.

2. The box body of the invention is provided with a secondary switch electrically connected with the motor, and only when the secondary switch is switched on and the conductive contact pieces of the stepping pedal and the top cover are also connected, the mousetrap can act to trap mice, so that the motor is prevented from being started mistakenly due to misoperation of the stepping pedal when the mousetrap is not arranged, and the safety and reliability of products are ensured. Moreover, the secondary switch is switched on by a push from the swinging rod when the mousetrap is arranged; therefore, once the mousetrap is arranged, the secondary switch is naturally switched on without the situation that the secondary switch is forgotten to be switched on, and the product stability is improved. In addition, when the clamping position and the locking part are unlocked and the support locking mechanism is rotated to reset, the swinging rod does not abut against the movable contact piece, so that the movable contact piece is separated from the fixed contact piece, the control circuit is completely powered off, the electric leakage condition is avoided, and the motor is prevented from being started mistakenly due to the misoperation of the stepping pedal; the secondary switch is simultaneously switched off by the rotation of the swinging rod to avoid the additional action that a user specially turns off the secondary switch, so that the mousetrap is more convenient and fast to use.

3. The invention is simple in structure, convenient to operation, high in action sensitivity, good in mouse trapping effect, and suitable for popularization and application.

### BRIEF DESCRIPTION OF THE DRAWINGS

FIG. 1 is a first perspective view of the invention;

FIG. 2 is an enlarged view of A in FIG. 1;

FIG. 3 is a second perspective view of the invention;

FIG. 4 is an enlarged view of B in FIG. 3;

FIG. 5 is a perspective view of the invention in a turnover process of the top cover;

FIG. 6 is a perspective view of the invention in a state of the top cover's flipping reset is completed;

FIG. 7 is a perspective view of a partial of the invention; and

FIG. 8 is another perspective view of a partial of the invention.

### DETAILED DESCRIPTION OF THE INVENTION

The invention is further described below with reference to the accompanying drawings.

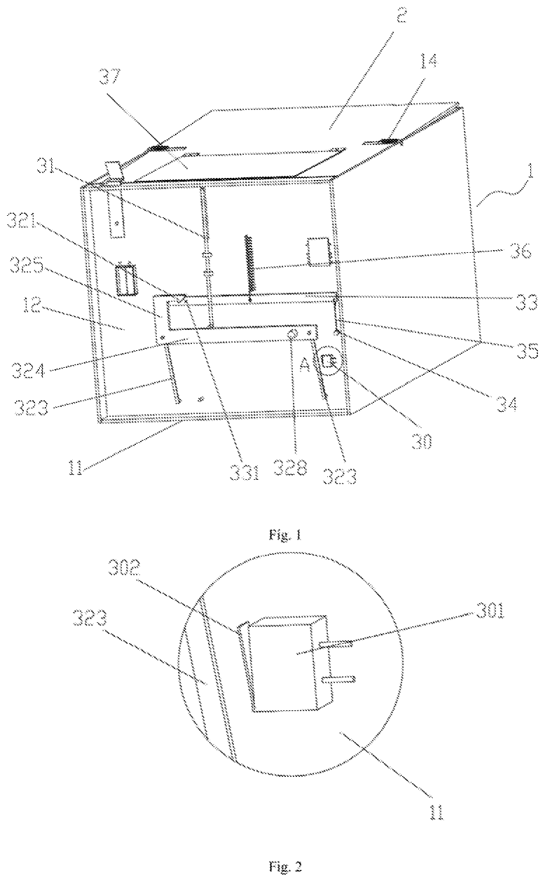

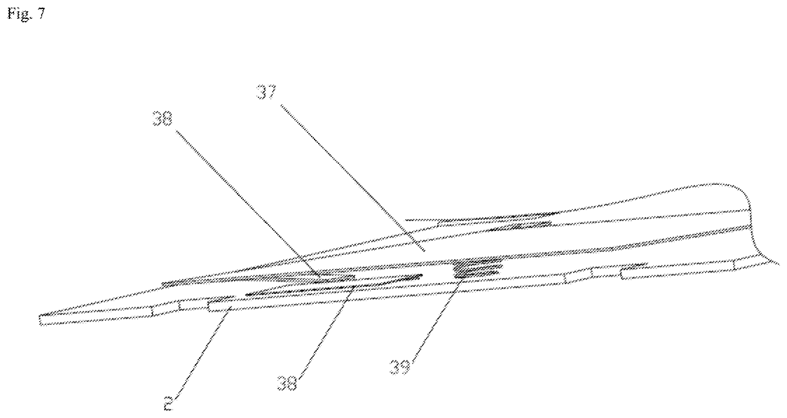

As shown in FIGS. 1-4 and 7, a mousetrap, comprising a box body 1 with an opening at the upper end, a top cover 2 which can rotate relative to the box body 1 to close the opening of the box body 1, and a trigger mechanism capable of being triggered by a mouse/mice climbing on the top cover 2 to turn over the top cover 2, the box body 1 includes a bottom plate 11 and a front side plate 12, and the top cover 2 is connected with the box body 1 by a connecting shaft/shafts 13; a torsion spring 14 capable of driving the top cover 2 to reset quickly is sleeved on each connecting shaft 13, the trigger mechanism includes a supporting rod/rods 31 capable of moving up and down relative to the front side plate 12 and supporting the top cover 2, the box body 1 is provided with a support locking mechanism capable of rotating relative to the box body 1 and supporting the supporting rod/rods 31, a transmission rod 33 is hinged to the front side plate 12, and the transmission rod 33 is provided with a clamping position 331 capable of engaging with a locking part 321 on the support locking mechanism; a motor is further provided on the box body 1, between the output shaft 34 of the motor and the transmission rod 33, a cable 35 capable of pulling the transmission rod 33 to rotate downwards for unlocking the clamping position 331 and the locking part 321 so as to enable the support locking mechanism to rotate for restoration is provided; a reset spring 36 configured for rotating the transmission rod 33 upwards to reset is also provided between the transmission rod 33 and the box body 1, and the top cover 2 is provided with a stepping pedal 37 which can move downwards after being treaded by a mouse, the stepping pedal 37 and the top cover 2 are respectively provided with a conductive contact piece 38 which can be contacted to energize the motor to rotate when the stepping pedal 37 moves downwards, and a return spring/return springs 39 capable of separating the conductive contact piece 38 of the stepping pedal 37 and the top cover 2 is/are further provided between the stepping pedal 37 and the top cover 2.

As shown in FIGS. 1 to 4, the box body 1 is further provided with a secondary switch 30 electrically connected with the motor; when the support locking mechanism rotates relative to the box body 1 to support the supporting rod/rods 31, the support locking mechanism drives the secondary switch 30 to be switched on, and when the support locking mechanism rotates to reset, the secondary switch 30 is switched off.

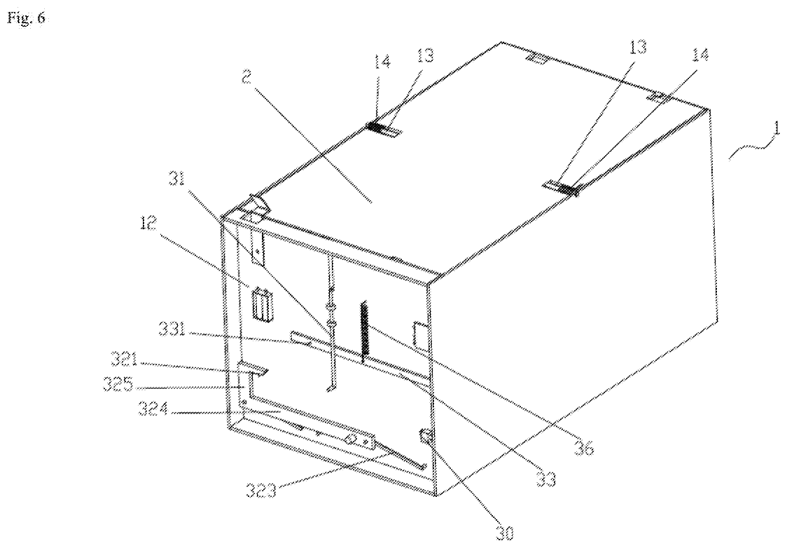

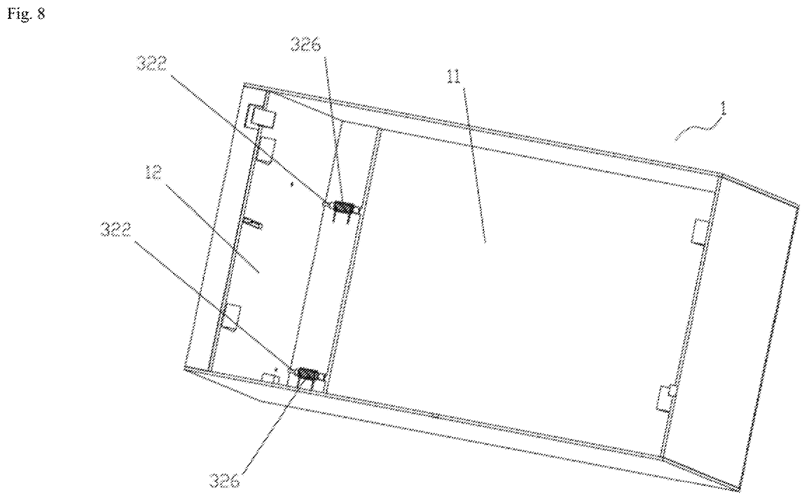

As shown in FIGS. 1, 3, 4, 5, 6 and 8, the support locking mechanism includes two rotating rods 322 hinged to the bottom plate 11, one end of each rotating rod 322 is bent to form a swinging rod 323, a linkage rod 324 hinged with the two swinging rods 323 and capable of pushing the supporting rod/rods 31 to move upwards when the rotating rods 322 rotate are arranged on the two swinging rods 323, the linkage rod 324 is provided with a locking rod 325 protruding upwards and the locking part 321 is provided on the locking rod 325; when the locking part 321 is clamped with the clamping position 331, the swinging rods 323 are in an inclined state respectively, so that when the locking part 321 is separated from the clamping position 331, the support locking mechanism can rotate to reset under the action of self gravity and the downward pressure of the top cover 2 by the supporting rod/rods 31.

A reset torsion spring 326 for driving the rotating rod 322 to rotate to reset when the locking part 321 and the clamping position 331 are unlocked is further provided between each rotating rod 322 and the bottom plate 11. When the locking part 321 is separated from the clamping position 331, the top cover 2 presses down the support locking mechanism by the supporting rod/rods 31, and cooperating with the action of the reset torsion spring/springs 326, the support locking mechanism rotates to reset more rapidly.

As shown in FIG. 2, the secondary switch 30 comprises a fixed contact piece 301 disposed on the box body 1 and an elastic movable contact piece 302 capable of contacting with or separating from the fixed contact piece 301; the movable contact piece 302 is pushed by the swinging rod 323 into engagement with the fixed contact piece 301 when the support locking mechanism rotates to support the supporting rod/rods 31, and the movable contact piece 302 is separated from the fixed contact piece 301 when the clamping position 331 and the locking part 321 are unlocked and the support locking mechanism rotates to reset.

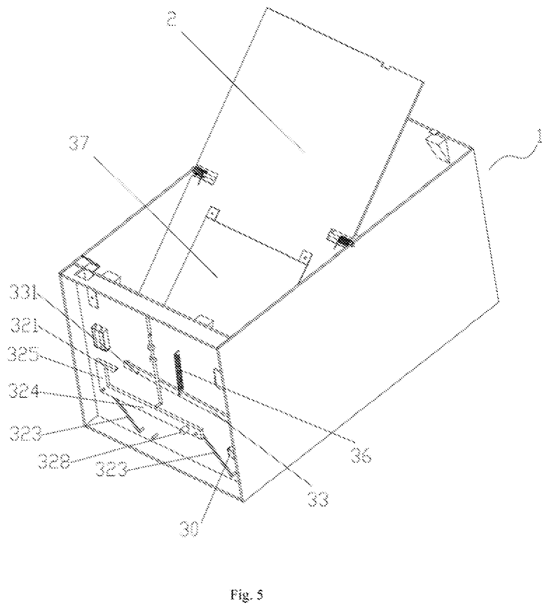

As shown in FIGS. 4 and 5, the clamping position 331 is a protruding column provided on the transmission rod 33, and the locking part 321 is a hook provided on the locking rod 325 and capable of hooking the protruding column.

As shown in FIG. 4, the hook is provided with an inclined plane 327 or an arc surface capable of pushing the protruding column so as to push the transmission rod 33 to rotate when the swinging rods 323 rotate.

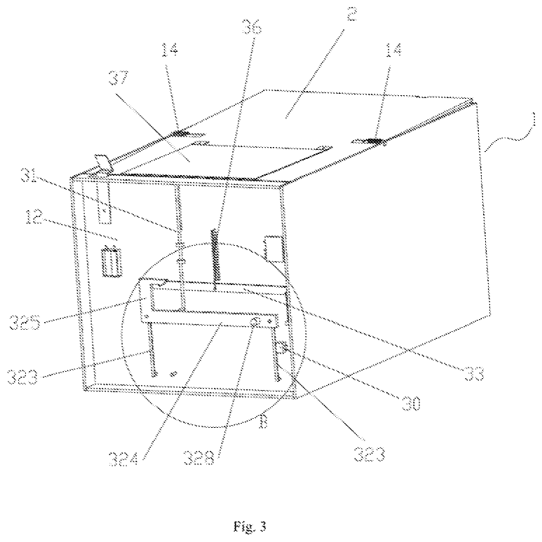

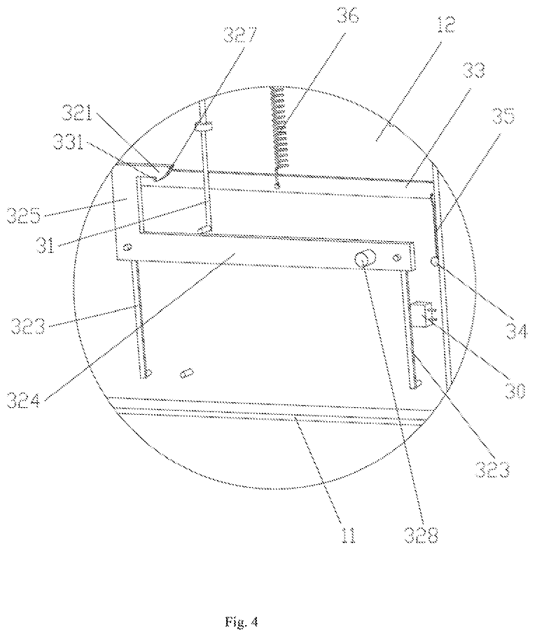

As shown in FIGS. 3 and 4, the linkage rod 324 is provided with a handle 328 at least for drawing the swinging rods 323 to rotate.

### Working Principles

The top cover 2 is firstly turned over, and then the handle 328 on the linkage rod 324 is pushed, so that the rotating rods 322 and the swinging rods 323 rotate; at the moment, the linkage rod 324 pushes the supporting rod 31 to move upwards in the rotating process of the rotating rods 322, and the support locking mechanism can support the top cover 2 by the supporting rod 31; during the rotation of the swinging rods 323, the inclined plane 327 of the locking part 321 pushes the protruding column of the transmission rod 33 and slides relative to the protruding column, and finally the locking part 321 hooks the protruding column of the transmission rod 33; at the moment, the clamping position 331 and the locking part 321 are locked, the support locking mechanism cannot rotate to reset, and the supporting rod/rods 31 keeps/keep supporting the top cover 2; and during the rotation of the swinging rods 324, the movable contact piece 302 of the secondary switch 30 is pushed by a swinging rod 324 into engagement with the fixed contact piece 301, and after the clamping position 331 and the locking part 321 are locked, the engagement of the movable contact piece 302 with the fixed contact piece 301 is maintained. At this time, the whole mechanism is in a stable state. At this point, the mousetrap setup is completed.

When a mouse climbs onto the top cover 2 and reaches the stepping pedal 37, the return spring/springs 39 between the stepping pedal 37 and the top cover 2 is/are insufficient to support the weight of the mouse, and the stepping pedal 37 moves downwards, so that the conductive contact piece 38 of the stepping pedal 37 is engaged with the conductive contact piece 38 on the top cover 2 to conduct a control circuit so as to energize the motor to rotate, and the cable 35 is wound during the rotation of the output shaft 34 of the motor, the transmission rod 33 is pulled to rotate downwards by the cable 35, so that the clamping position 331 of the transmission rod 33 is separated from the locking part 321 of the supporting and locking mechanism, and the support locking mechanism rotates to reset under the action of the reset torsion spring 326; at the moment, the supporting rod 31 loses/the supporting rods 31 lose support of the support locking mechanism, the supporting rod 31 moves/the supporting rods 31 move downwards, the top cover 2 loses support and is quickly overturned downwards to reset under the action of the torsion spring/springs 14; and the mouse on the top cover 2 falls into the box body 1 during the flipping reset, and the top cover 2 closes the opening of the box body 1 after being overturned and reset, so that the mouse is captured in the box body 1. Due to the fact that the electric circuit is connected by the conductive contact pieces 38 to enable the motor to rotate, once the motor rotates, the clamping position 331 and the locking part 321 are unlocked, the top cover 2 is turned over, the triggering of the trigger mechanism is controlled by the electric control signal, so that the trigger mechanism is higher in sensitivity, the phenomenon of clamping stagnation does not occur, the mouse can be captured in the box body 1 as long as the mouse steps on the stepping pedal 37, with good mouse trapping effect.

The box body 1 is provided with a secondary switch 30 electrically connected with the motor, and only when the secondary switch 30 is switched on and the conductive contact pieces 38 of the stepping pedal 37 and the top cover 2 are also switched on , the mousetrap can act to trap mice, so that the motor is prevented from being started mistakenly due to misoperation of the stepping pedal 37 when the mousetrap is not arranged, and the safety and reliability of products are ensured. Moreover, the secondary switch 30 is switched on by a push from the swinging rod 323 when the mousetrap is arranged; therefore, once the mousetrap is arranged, the secondary switch 30 is naturally switched on without the situation that the secondary switch 30 is forgotten to be switched on, and the product stability is improved. In addition, when the clamping position 331 and the locking part 321 are unlocked and the support locking mechanism rotates to reset, the swinging rod 323 does not abut against the movable contact piece 302, so that the movable contact piece 302 is separated from the fixed contact piece 301, the control circuit is completely powered off, the electric leakage condition is avoided, and the motor is prevented from being started mistakenly due to the misoperation of the stepping pedal 37. The secondary switch 30 is simultaneously switched off by the rotation of the swinging rod 323 to avoid the additional action that a user specially closes the secondary switch 30, so that the mousetrap is more convenient and fast to use.

1. A mousetrap, comprising a box body with an opening at the upper end, a top cover which can rotate relative to the box body to close the opening of the box body, and a trigger mechanism capable of being triggered by a mouse/mice climbing on the top cover to turn over the top cover, the box body includes a bottom plate and a front side plate, wherein the trigger mechanism includes a supporting rods/supporting rods capable of moving up and down relative to the front side plate and supporting the top cover, the box body is provided with a support locking mechanism capable of rotating relative to the box body and supporting the supporting rod/rods, a transmission rod is hinged to the front side plate, and the transmission rod is provided with a clamping position capable of engaging with a locking part on the support locking mechanism; a motor is further provided on the box body, between the output shaft of the motor and the transmission rod, a cable capable of pulling the transmission rod to rotate downwards for unlocking the clamping position and the locking part so as to enable the support locking mechanism to rotate for restoration is provided; a reset spring configured for rotating the transmission rod upwards to reset is also provided between the transmission rod and the box body, and the top cover is provided with a stepping pedal which can move downwards after being treaded by a mouse, the stepping pedal and the top cover are respectively provided with a conductive contact piece which can be contacted to energize the motor to rotate when the stepping pedal moves downwards, and a return spring/return springs capable of separating the conductive contact pieces of the stepping pedal and the top cover is/are further provided between the stepping pedal and the top cover.

2. The mousetrap according to claim 1, wherein the box body is further provided with a secondary switch electrically connected with the motor; when the support locking mechanism rotates relative to the box body to support the supporting rod/rods, the support locking mechanism drives the secondary switch to be switched on, and when the support locking mechanism rotates to reset, the secondary switch is switched off.

3. The mousetrap according to claim 2, wherein the support locking mechanism includes two rotating rods hinged to the bottom plate, one end of each rotating rod is bent to form a swinging rod, a linkage rod hinged with the two swinging rods and capable of pushing the supporting rod/rods to move upwards when the rotating rods rotate are arranged on the two swinging rods, the linkage rod is provided with a locking rod protruding upwards, and the locking part is arranged on the locking rod; when the locking part is clamped with the clamping position, the swinging rods are in an inclined state respectively, so that when the locking part is separated from the clamping position, the support locking mechanism can rotate to reset under the action of self gravity and the downward pressure of the top cover by the supporting rod/rods.

4. The mousetrap according to claim 3, wherein a reset torsion spring for driving the rotating rod to rotate to reset when the locking part and the clamping position are unlocked is further arranged between each rotating rod and the bottom plate.

5. The mousetrap according to claim 1, wherein the top cover and the box body are connected by a connecting shaft/connecting shafts, and a torsion spring capable of driving the top cover to reset quickly is sleeved on each connecting shaft.

6. The mousetrap according to claim 3, wherein the secondary switch comprises a fixed contact piece disposed on the box body and an elastic movable contact piece capable of contacting with or separating from the fixed contact piece; the movable contact piece is pushed by the swinging rod into engagement with the fixed contact piece when the support locking mechanism rotates to support the supporting rod/rods, and the movable contact piece is separated from the fixed contact piece when the clamping position and the locking part are unlocked and the support locking mechanism rotates to reset.

7. The mousetrap according to claim 3, wherein the clamping position is a protruding column provided on the transmission rod, and the locking part is a hook provided on the locking rod and capable of hooking the protruding column.

8. The mousetrap according to claim 7, wherein the hook is provided with an inclined plane or an arc surface capable of pushing the protruding column so as to push the transmission rod to rotate when the swinging rods rotate.

9. The mousetrap according to claim 7, wherein the linkage rod is provided with at least one handle for drawing the swinging rods to rotate.

10. The mousetrap according to claim 4, wherein the clamping position is a protruding column provided on the transmission rod, and the locking part is a hook provided on the locking rod and capable of hooking the protruding column.

11. The mousetrap according to claim 6, wherein the clamping position is a protruding column provided on the transmission rod, and the locking part is a hook provided on the locking rod and capable of hooking the protruding column.
